(19) United States
(12) Patent Application Publication
(10) Pub. No.: US 2018/0114390 A1
(43) Pub. Date: Apr. 26, 2018

(54) IDENTIFICATION AND ENTRY SYSTEM AND METHOD ACTIVATED BY DISTANCE

(71) Applicant: NIO NEXTEV LIMITED, Hong Kong (CN)

(72) Inventor: Yiwei DONG, Shanghai (CN)

(21) Appl. No.: 15/792,045

(22) Filed: Oct. 24, 2017

(30) Foreign Application Priority Data
Oct. 25, 2016 (CN) 201610938201.5

(51) Int. Cl. G07C 9/00

(52) U.S. Cl. CPC G07C 9/00896; G07C 2009/00928

(57) ABSTRACT

The present application relates to an identification system, particularly to identification and entry system and method activated by distance. The application aims at solving security problems in existing identification field. To this end, the identification system of the application comprises a feature gathering module for gathering distinctive features of detected object and a control module in communication with the feature gathering module, which is used for activating the feature gathering module when distance between the detected object and a certain area is shorter than a specific threshold, and also used for opening the certain area for the detected object to enter when the distinctive features of the detected object gathered by the feature gathering module match previously stored distinctive features of the detected object. The technical solutions of the application can effectively prevent those objects with misleading or counterfeit identification features from being identified as legal ones and being allowed to enter a certain area, thereby greatly improving the security and reliability of the identification system.

### CROSS-REFERENCE TO RELATED APPLICATIONS

This application claims the benefit of China Application No. 201610938201.5 filed Oct. 25, 2016, the entire contents of which are incorporated herein by reference.

### TECHNICAL FIELD

The present application relates to an identification system, particularly to identification and entry system and method activated by distance.

### BACKGROUND

In modern society, there is an increasing demand for vehicles to meet travel requirements. Accordingly, the need for high quality vehicle management service has been on the rise. Typically, a driver needs to get off the vehicle and open the garage door before driving into it, which is in convenient. To further improve the convenience of parking, a camera equipped by the garage takes photos of the vehicle's license plate, and the number extracted from the image of the license plate is compared with the plate number previously stored in a database, when they match each other, the garage door will open automatically. However, there are some security problems with this practice. For example, when a vehicle with a counterfeit plate is trying to get into the garage, the garage door will falsely open, since the camera will take photos of the fake plate and the plate number on this plate image will match the plate number in the database.

Further, the above described abnormal situation is not unique for automatic garage opening, but widely exists in identification field. That is to say, there are risks for current identification systems: unauthorized entities may make themselves be identified by means of their misleading or counterfeit features, so as to enter a certain area in which only authorized objects are permitted.

Therefore, to resolve the above described problems, there is a need in the art for an identification system of greater security and reliability.

### SUMMARY

To resolve the above mentioned problems in the prior art, i.e., the security problems in current identification field, the present application provides an identification and entry system activated by distance. The system comprises: a feature gathering module for gathering distinctive features of detected object; a control module in communication with the feature gathering module, which is used for activating the feature gathering module when distance between the detected object and a certain area is shorter than a specific threshold; wherein the control module opens the certain area for the detected object to enter when the distinctive features of the detected object gathered by the feature gathering module match previously stored distinctive features of the detected object.

In an optimized embodiment of the above described system, the system further includes a positioning module which is in communication with the control module to provide the real time distance between the detected object and the certain area to the control module.

In an optimized embodiment of the above described system, the system further includes a communication module which is used to facilitate communication among the control module, the feature gathering module and the positioning module.

In an optimized embodiment of the above described system, the feature gathering module compares the gathered distinctive features of the detected object with the previously stored distinctive features to determine the matching degree between the gathered features and the stored features; when they match, the feature gathering module sends a signal to the control module which then opens the certain area allowing the detected object to enter.

In an optimized embodiment of the above described system, the gathered distinctive features of the detected object are sent by the feature gathering module to the control module which then compares the gathered distinctive features with the previously stored distinctive features to determine the matching degree between them; when they match, the control module opens the certain area for the detected object to enter.

In an optimized embodiment of the above described system, the positioning module is a GPS module.

In an optimized embodiment of the above described system, the detected object is a vehicle, the distinctive features are information on license plate of the vehicle, and the certain area is a garage or parking space.

In an optimized embodiment of the above described system, the feature gathering module is a license plate identification module, which includes a camera used for taking photos of the license plate information.

In an optimized embodiment of the above described system, the license plate identification module compares the plate information taken by the camera with previously stored plate information to determine the matching degree between them; when they match, the license plate identification module sends a signal to the control module, which then opens lock of the garage door or the parking space for the vehicle to enter.

In an optimized embodiment of the above described system, the license plate information taken by the camera is sent by the license plate identification module to the control module, which compares the received license plate information with previously stored license plate information to determine their matching degree; when they match, the control module opens lock of the garage door or the parking space for the vehicle to enter.

The present application also provides an identification and entry method activated by distance, the method includes the following steps: determining distance between detected object and a certain area; activating a feature gathering module when the distance between the detected object and the certain area is shorter than a specific threshold; gathering distinctive features of the detected object by the activated feature gathering module; opening the certain area by means of a control module for the detected object to enter, when the distinctive features gathered by the feature gathering module match previously stored distinctive features.

In an optimized embodiment of the above described method, the method further includes providing to the control module the real time distance between the detected object and the certain area by the positioning module.

In an optimized embodiment of the above described method, the method further includes facilitating communication among the control module, the feature gathering module and the positioning module by means of a communication module.

In an optimized embodiment of the above described method, the feature gathering module compares the gathered distinctive features with previously stored distinctive features to determine the matching degree between them; when they match, the feature gathering module sends a signal to the control module, which then opens the certain area for the detected object to enter.

In an optimized embodiment of the above described method, the feature gathering module sends the gathered distinctive features of the detected object to the control module, which compares the gathered features with previously stored distinctive features so as to determine the matching degree between them; when they match, the control module opens the certain area for the detected object to enter.

In an optimized embodiment of the above described method, the positioning module is a GPS module.

In an optimized embodiment of the above described method, the detected object is a vehicle, the distinctive features are information on license plate of the vehicle, and the certain area is a garage or parking space.

In an optimized embodiment of the above described method, the feature gathering module is a license plate identification module, which includes a camera used for taking photos of the license plate information.

In an optimized embodiment of the above described method, the license plate identification module compares the license plate information taken by the camera with previously stored license plate information to determine the matching degree between them; when they match, the license plate identification module sends a signal to the control module, which then opens lock of the garage door or the parking space for the vehicle to enter.

In an optimized embodiment of the above described method, the license plate information taken by the camera are sent by the license plate identification module to the control module, which compares the license plate information taken by the camera with previously stored license plate information to determine their matching degree; when they match, the control module opens lock of the garage door or the parking space for the vehicle to enter.

In the technical solutions of the application, the feature gathering module is normally in sleep or closed state and is activated by the control module only when the detected object moves within a certain distance from the certain area. That is to say, if the object within the distance is not an authorized one, then the feature gathering module will not be activated, effectively preventing objects with misleading or counterfeit features from entering the certain area. Therefore, the technical solutions of the present application greatly improve the security and reliability of the identification system. Especially in the case of automatic garage/parking space opening, the control module will activate the license plate identification module only when the vehicle belonging to the garage/parking space reaches within a certain distance of the garage or parking space, thereby avoiding the situation of falsely opening the garage/parking space on account of such illegal acts as counterfeiting license plate.

### BRIEF DESCRIPTION OF DRAWINGS

FIG. 1 is a structural schematic view of an identification and entry system activated by distance of the application; and

FIG. 2 is a flow chart of an identification and entry method activated by distance of the application.

### DETAILED DESCRIPTION

The preferred embodiments of the application are described below with reference to the accompanying figures. As will be understood by those skilled in the art, these embodiments are simply used for interpreting the technical principle of the application and are not intended to limit its protection scope in any way.

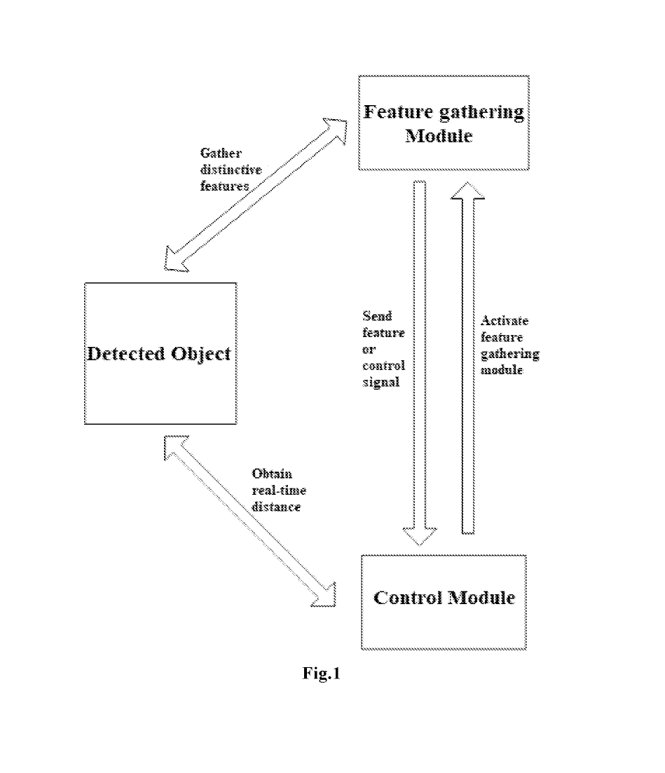

As shown in FIG. 1, an identification and entry system activated by distance of the application comprises a feature gathering module and a control module. Specifically, the feature gathering module is used for gathering distinctive features of the detected object and communicates with the control module which is used for activating the feature gathering module when the distance between the detected object and a certain area is shorter than a specific threshold, and also used for opening the certain area for the detected object to enter when the distinctive features acquired from the detected object by the feature gathering module match previously stored distinctive features of the object. Although not shown in FIG. 1, the system also includes a positioning module and a communication module. Specifically, the communication module is used to facilitate communication among the control module, the feature gathering module and the positioning module. The distance between the detected object and the certain area can be detected by the positioning module in real time, the control module communicates with the positioning module and acquires the information about the distance from the same. The feature gathering module is in sleep or closed state before the control module activates it. The feature gathering module is activated by the control module only if the distance between detected object and the certain area is shorter than a specific threshold. It will not be activated by the control module, if it is unauthorized object that comes within a particular range of the specific area, effectively preventing unauthorized object from entering the area via misleading or counterfeit identification features. It is to be noted that the certain area mentioned in the embodiment refers to those areas accessible only by authorized objects, such as garage, parking space and warehouse. The specific threshold can be flexibly set according to specific application and requirement. In case of a garage or parking space, it can be set at 10 meters or 20 meters and so on. Furthermore, the control module can be fixed on the detected object or any other suitable positions, as long as it is able to activate the feature gathering module when the distance between the detected object and the specific area is shorter than the specific threshold.

Referring still to FIG. 1, the feature gathering module gathers the distinctive features of the detected object after its activation. Specifically, the distinctive features may typically be identification features, for instance license plate number, shape of the detected object, label or fingerprint, etc. The distinctive features of the detected object are previously stored within the feature gathering module or control module (or within an independent storage module, such as a remote memory), so long as they can be obtained by the feature gathering module or control module whenever necessary. In an embodiment of the application, the feature gathering module compares the distinctive features of the detected object gathered with the previously stored distinctive features to determine the matching degree between the gathered features and the stored features. When they match each other very well, the feature gathering module sends a signal to the control module, which then opens the specific area allowing the detected object to enter. In another embodiment of the application, the feature gathering module sends the distinctive features to the control module, and the control module compares the distinctive features with the previously stored distinctive features to determine the matching degree between them. When they match, the control module directly opens the specific area allowing the detected object to enter. Preferably, the positioning module of the application is a GPS module.

For further illustration of specific embodiments of the identification and entry system activated by distance of the present application, an example in which the opening of a garage/parking space is controlled by identifying information on license plates, is described below. In this case, the detected object is a vehicle, the feature gathering module is a license plate identification module, the distinctive features are the information on the license plate, and the certain area is a garage or parking space. Specifically, the license plate identification module includes a camera used for photographing plate information. More specifically, the camera takes photos of the license plate of the vehicle, the plate number on the license plate is then identified by the license plate identification module and compared with previously stored distinctive features (license plates numbers). When detected vehicle is moving toward a garage/parking space, the distance between the vehicle and the garage/parking space is sent to the control module by the positioning module in real time. When the distance is smaller than the specific threshold, the license plate identification module is activated and takes photos of the plate with its camera and identifies the number of the plate. In an embodiment of the application, the license plate identification module compares the plate number identified directly with previously stored plate numbers to acquire the matching degree between them. When he identified plate number matches a previously stored plate number, the license plate identification module sends a signal to the control module, which then opens the garage/parking space for the detected vehicle to enter. In another embodiment of the application, the license plate identification module sends the plate number identified to the control module, which compares the identified plate number with previously stored plate numbers to determine their matching degree. When they match, the control module directly opens the garage/parking space allowing the vehicle to enter.

The feature gathering module is normally in sleep or closed state and is activated by the control module only when an authorized vehicle reaches within a certain distance from the garage/parking space. That is to say, if the vehicle within the distance is not an authorized one (not belonging to the garage/parking space), then the feature gathering module will not be activated, effectively preventing vehicles with counterfeit plates from being identified as legal ones by the feature gathering module. As such, the situation of falsely opening the garage/parking space is avoided, greatly improving security and reliability of the identification system.

With respect to plate identification, it is to be noted that although the present application is described in combination with license plate number, as would be understood by those skilled in the art, the description is merely exemplary; in case of garage/parking space, the distinctive features can be information other than plate information such as the shape of measured vehicle, and plate information is not limited to plate number either, but can be other information on the license plate, such as a special two-dimension code.

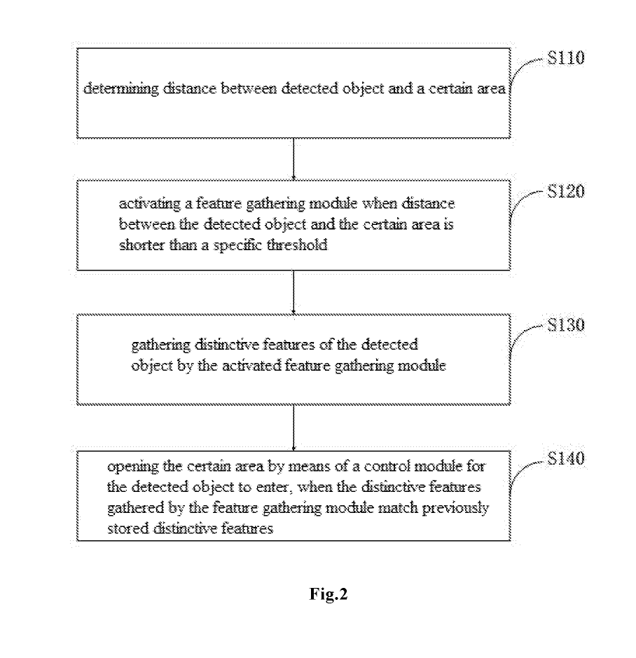

Also provided is an identification and entry method activated by distance. With reference to FIG. 2, FIG. 2 is a flow diagram of the identification and entry method activated by distance of the present application. As shown in FIG. 2, the method includes several steps. Specifically, in step S110, the distance between the detected object and the certain area is determined. In step S120, when the distance between them is shorter than a specific threshold, the feature gathering module is activated. In step S130, the distinctive features of the detected object are gathered by the activated feature gathering module. In step S140, when the distinctive features gathered by the feature gathering module match previously stored distinctive features, the certain area is opened by a control module for the detected object to enter. More specifically, in the method, the control module, the feature gathering module and the positioning module are in communication with each other by means of a communication module. In step S110, the real time distance between the detected object and the certain area is obtained by the control module from the positioning module. In an embodiment of the step S140, the feature gathering module compares the gathered distinctive features with previously stored distinctive features to determine the matching degree between them. When they match, the feature gathering module sends a signal to the control module, which then opens the certain area for the detected object to enter. In another embodiment of the step S140, the feature gathering module sends the distinctive features gathered to the control module, which compares the gathered features with the previously stored distinctive features so as to determine the matching degree between them. When they match, the control module opens the certain area for the detected object to enter. Preferably, in the method of the application, the positioning module can be a GPS module.

To further illustrate the method of the application, an example in which the garage/parking space is automatically opened by this method is described below. In this case, the detected object is a vehicle, the feature gathering module is a license plate identification module, the distinctive features are the information on the license plate (specifically, the plate number), and the certain area is a garage or parking space. Specifically, the license plate identification module includes a camera used for taking photos of plate information. In the above mentioned method, the distance between the vehicle and the garage/parking space is determined during step S110. In step S120, when the distance between them is shorter than the specific threshold, the license plate identification module is activated. In step S130, the license plate number of the vehicle is obtained by the activated license plate identification module, specifically by taking photos of the plate with the camera and by processing the photos of the plate thus taken. In step S140, when the plate number obtained by the license plate identification module matches one of the previously stored plate numbers, the garage/parking space is opened by the control module for the vehicle to enter. More specifically, in an embodiment of step S140, the license plate identification module compares the plate information taken by the camera with those previously stored to determine the matching degree between them; when they match, the license plate identification module sends a signal to the control module, which then opens the garage door or the parking space's lock for the vehicle to enter. In another embodiment of step S140, the license plate identification module sends the plate information taken by the camera to the control module which compares the plate information with those previously stored to determine the matching degree between them; when they match, the control module opens the garage door or the parking space's lock for the vehicle to enter.

The feature gathering module is normally in sleep or closed state and is activated by the control module only when an authorized vehicle reaches within a certain distance from the garage/parking space. That is to say, if the vehicle within the distance is not an authorized one (not belonging to the garage/parking space), then the feature gathering module will not be activated, effectively preventing vehicles with counterfeit plates from being identified as legal one by the feature gathering module. As such, the situation of falsely opening the garage/parking space is avoided, greatly improving the security and reliability of the identification system.

So far the technical solutions of the present application has been described in connection with the preferred embodiments shown in the accompanying figures, it can be readily understood by those skilled in the art that the protection scope of the application is obviously not limited to these specific embodiments. Without departing from the principles of the application, equivalent alterations or substitutions of related technical features can be made by those skilled in the art, these altered or substituted technical solutions will fall within the protection scope of the application.

What is claimed is:

1. An identification and entry system activated by distance, comprising:
a feature gathering module for gathering distinctive features of detected object;
a control module in communication with the feature gathering module, which is used for activating the feature gathering module when distance between the detected object and a certain area is shorter than a specific threshold;
wherein the control module opens the certain area for the detected object to enter when the distinctive features of the detected object gathered by the feature gathering module match previously stored distinctive features of the detected object.

2. The identification and entry system activated by distance as set forth in claim 1, wherein the system further includes a positioning module which is in communication with the control module to provide real time distance between the detected object and the certain area to the control module.

3. The identification and entry system activated by distance as set forth in claim 2, wherein the system further includes a communication module which is used to facilitate communication among the control module, the feature gathering module and the positioning module.

4. The identification and entry system activated by distance as set forth in claim 1, wherein the feature gathering module compares the gathered distinctive features of the detected object with the previously stored distinctive features to determine the matching degree between the gathered features and the stored features; when they match, the feature gathering module sends a signal to the control module which then opens the certain area allowing the detected object to enter.

5. The identification and entry system activated by distance as set forth in claim 1, wherein the gathered distinctive features of the detected object are sent by the feature gathering module to the control module which then compares the gathered distinctive features with the previously stored distinctive features to determine the matching degree between them; when they match, the control module opens the certain area for the detected object to enter.

6. The identification and entry system activated by distance as set forth in claim 2, wherein the positioning module is a GPS module.

7. The identification and entry system activated by distance as set forth in claim 1, wherein the detected object is a vehicle, the distinctive features are information on license plate of the vehicle, and the certain area is a garage or parking space.

8. The identification and entry system activated by distance as set forth in claim 7, wherein the feature gathering module is a license plate identification module, which includes a camera used for taking photos of the license plate information.

9. The identification and entry system activated by distance as set forth in claim 8, wherein the license plate identification module compares the plate information taken by the camera with previously stored plate information to determine the matching degree between them; when they match, the license plate identification module sends a signal to the control module, which then opens lock of the garage door or the parking space for the vehicle to enter.

10. The identification and entry system activated by distance as set forth in claim 7, wherein the feature gathering module is a license plate identification module which includes a camera used for taking photos of the license plate information.

11. The identification and entry system activated by distance as set forth in claim 10, wherein the license plate information taken by the camera is sent by the license plate identification module to the control module which compares the received license plate information with previously stored license plate information to determine their matching degree; when they match, the control module opens lock of the garage door or the parking space for the vehicle to enter.

12. An identification and entry method activated by distance, comprising the following steps:
determining distance between detected object and a certain area;
activating a feature gathering module when distance between the detected object and the certain area is shorter than a specific threshold;
gathering distinctive features of the detected object by the activated feature gathering module;
opening the certain area by means of a control module for the detected object to enter, when the distinctive features gathered by the feature gathering module match previously stored distinctive features.

13. The identification and entry method activated by distance as set forth in claim 12, wherein the method further includes providing to the control module real time distance between the detected object and the certain area by the positioning module.

14. The identification and entry method activated by distance as set forth in claim 13, wherein the method further includes facilitating communication among the control module, the feature gathering module and the positioning module by means of a communication module.

15. The identification and entry method activated by distance as set forth in claim 12, wherein the feature gathering module compares the gathered distinctive features with previously stored distinctive features to determine the matching degree between them; when they match, the feature gathering module sends a signal to the control module which then opens the certain area for the detected object to enter.

16. The identification and entry method activated by distance as set forth in claim 12, wherein the feature gathering module sends the gathered distinctive features of the detected object to the control module which compares the gathered features with previously stored distinctive features to determine the matching degree between them; when they match, the control module opens the certain area for the detected object to enter.

17. The identification and entry method activated by distance as set forth in claim 13, wherein the positioning module is a GPS module.

18. The identification and entry method activated by distance as set forth in claim 12, wherein the detected object is a vehicle, the distinctive features are information on license plate of the vehicle, and the certain area is a garage or parking space.

19. The identification and entry method activated by distance as set forth in claim 18, wherein the feature gathering module is a license plate identification module which includes a camera used for taking photos of the license plate information.

20. The identification and entry method activated by distance as set forth in claim 19, wherein, the license plate identification module compares the license plate information taken by the camera with previously stored license plate information to determine the matching degree between them; when they match, the license plate identification module sends a signal to the control module which then opens lock of the garage door or the parking space for the vehicle to enter.

21. The identification and entry method activated by distance as set forth in claim 18, wherein the feature gathering module is a license plate identification module which includes a camera used for taking photos of the license plate information.

22. The identification and entry method activated by distance as set forth in claim 21, wherein the license plate information taken by the camera are sent by the license plate identification module to the control module which compares the license plate information taken by the camera with previously stored license plate information to determine their matching degree; when they match, the control module opens lock of the garage door or the parking space for the vehicle to enter.
